(19) United States
(12) Patent Application Publication
(10) Pub. No.: US 2007/0000358 A1
(43) Pub. Date: Jan. 4, 2007

(54) Split ring opening tool

(75) Inventors: Tatsuya Sakai, Irvine, CA (US); Hisashi Horibe, Gifu-Prefecture (JP)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: Shimano American Corporation, Irvine, CA (US)

(21) Appl. No.: 11/173,262

(22) Filed: Jun. 30, 2005

(51) Int. Cl. B25B 7/02; B25B 25/00

(52) U.S. Cl. 81/426; 81/485

(57) ABSTRACT

A tool for opening split rings including first and second intersecting members pivotable at their intersection between an open position and a closed position. The first and second intersecting members include first and second handle portions and first and second jaw portions, respectively. One of the first and second jaw portions includes a first split ring opener formed integrally therewith, and one of the first and second jaw portions includes a second split ring opener attached thereto.

### FIELD OF THE INVENTION

The present invention relates generally to hand tools and, more particularly, to hand tools that can be used to open split rings.

### BACKGROUND OF THE INVENTION

Split rings are used for retaining keys together and they are also used for connecting various and sundry parts together in many different applications. The use of split rings for interconnecting fishing tackle parts such as leaders and spoons is illustrative of but one of the many use applications for such annular elements. Fisherman for grasping and holding hooks and lures and for cutting wire, leader, fishing line and lead, often uses conventional needlenose pliers.

The conventional split ring is formed from an elongated metal element that is wound to provide two contiguous turns or convolutions that touch one another along confronting sides. This arrangement makes it necessary to spread the convolutions apart in order to open the ring for reception of a key or other object that is to be attached thereto. The object is equipped with an eye or opening through which one of the convolutions is threaded in attaching the object to the ring. When the convolutions are spread apart to receive an object, the metal of the ring is stressed and unless the elastic limit of the metal is exceeded when thus spread apart, the metal recovers its original shape so that the convolutions again become contiguous after the object is attached to the ring and the convolution spreading forces are removed. This metal recovery precludes the removal of the object from the ring until such time as the convolutions are again spread apart for such purposes.

Split rings of the size normally used for attaching keys together are relatively easy to manipulate with the fingers and the convolutions are rarely spread sufficiently far enough apart by a person to exceed the elastic limit and cause permanent deformation of the split ring. On the other hand, split rings which are smaller in size and of the size commonly used in attaching fishing tackle parts are more difficult to open with the fingers and the metal is more frequently stressed beyond its elastic limit as the object or tackle part is attached to the ring. This, of course, makes the split ring unsuitable for its intended purpose and requires a replacement.

In the fishing tackle industry, as well as in other industries, the need arises for attaching various different objects to small split rings that may vary in size from one object to the next and this type work is done by hand. As such, the work is tedious and it would be beneficial to have a tool which would aid the worker in accomplishing the task as well as diminish the number of split rings that are destroyed by exceeding the elastic limit of the metal during the attachment procedures.

### SUMMARY OF THE PREFERRED EMBODIMENTS

In accordance with a first aspect of the present invention, there is provided a tool including first and second intersecting members pivotable at their intersection between an open position and a closed position. The first and second intersecting members include first and second handle portions and first and second jaw portions, respectively. One of the first and second jaw portions includes a first split ring opener formed integrally therewith, and one of the first and second jaw portions includes a second split ring opener attached thereto.

In accordance with another aspect of the present invention there is provided a tool including first and second intersecting members pivotable at their intersection between an open position and a closed position. The first and second intersecting members including first and second handle portions and first and second jaw portions, respectively. The first intersecting member includes a split ring opener attached thereto at a location between its tip and the intersection of the first and second intersecting members. The split ring opener includes a cutting portion formed integrally therewith that includes a cutting edge and defines an insertion slot extending away from the cutting edge.

In accordance with yet another aspect of the present invention, there is provided a tool including first and second intersecting members pivotable at their intersection between an open position and a closed position. The first and second intersecting members include first and second handle portions and first and second jaw portions, respectively. The first jaw portion includes a first split ring opener formed on a tip thereof that overlaps a tip of the second jaw portion when the first and second intersecting members are in the closed position. The first jaw portion defines a longitudinal axis and the first split ring opener is oriented at approximately a right angle to that longitudinal axis. The first jaw portion also includes a second split ring opener attached thereto at a location between the tip and the intersection of the first and second intersecting members. The second split ring opener overlaps a side of the second jaw portion when the first and second intersecting members are in the closed position, and the second split ring opener includes a cutting portion formed integrally therewith. The cutting portion includes a cutting edge and defines an insertion slot extending away from the cutting edge. The tip of the first intersecting member includes a notch defined therein.

In accordance with a further aspect of the present invention there is provided a method for making a split ring opening tool. The method includes the steps of providing first and second intersecting members pivotable at their intersection between an open position and a closed position, wherein the first and second intersecting members include first and second handle portions and first and second jaw portions, respectively; forming a first split ring opener on a tip of the first jaw portion; attaching a second split ring opener to one of the first or second jaw portions at a location between the tip and the intersection of the first and second intersecting members; and defining a notch in the tip of the first intersecting member. The second split ring opener includes a cutting portion formed integrally therewith. The cutting portion includes a cutting edge and defines an insertion slot extending away from the cutting edge.

### BRIEF DESCRIPTION OF THE DRAWINGS

The invention may be more readily understood by referring to the accompanying drawings in which:

FIG. 1 is a side elevational view showing a split ring opening tool in an open position in accordance with a first preferred embodiment of the present invention;

FIG. 2 is a detailed perspective view of the split ring opening tool of FIG. 1 showing the first and second split ring openers and the cutting portion; and

FIG. 3 is a top elevational view of the split ring opening tool of FIG. 1.

Like numerals refer to like parts throughout the several views of the drawings.

### DETAILED DESCRIPTION OF THE PREFERRED EMBODIMENTS

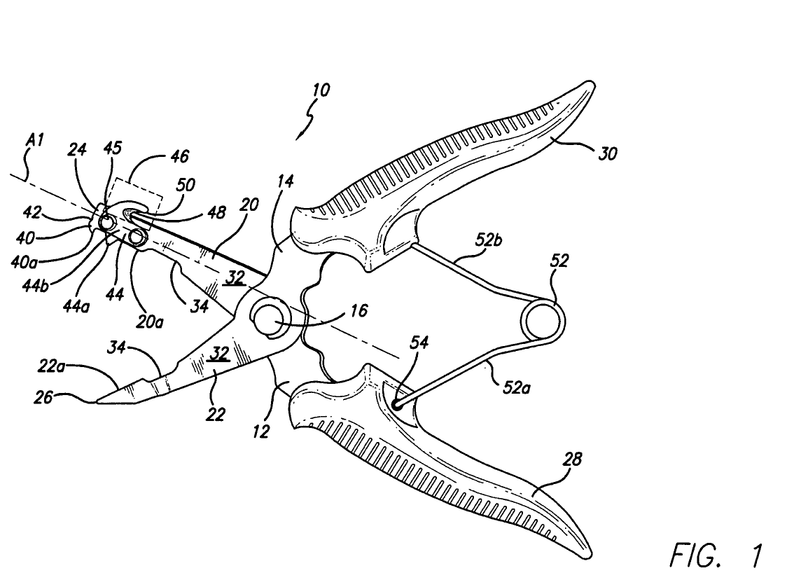

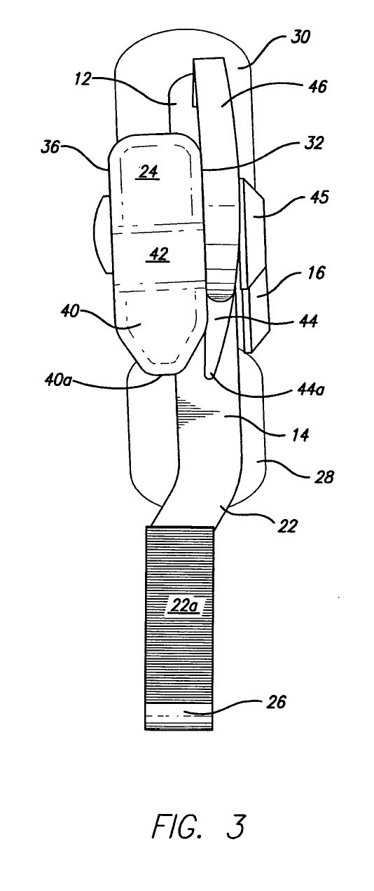

Referring to FIGS. 1-3, a tool 10 for opening split rings is shown. Split rings are commonly found on fishing lures and tool 10 can be used for opening such split rings. However, this is only exemplary and is not intended to be a limitation on the present invention. It will be understood that the tool 10 can be used to open split rings associated with any number of items. Other uses for the tool described herein will be readily apparent to those skilled in the relevant art.

It will be appreciated that terms such as “top,” “bottom,” and “side” used herein are used merely for ease of description and refer to the orientation of the components as shown in the Figures. It should be understood that any orientation of the various embodiments of the tool 10 and the components thereof described herein is within the scope of the present invention.

The tool 10 includes first and second intersecting members 12 and 14 that are pivotally interconnected between their opposite ends by a pin 16 that is fixed to the element first intersecting member 14 and extends through a suitable opening in member 12. Pin 16 establishes an axis for relative pivotal movement of first and second intersecting members 12 and 14. Other known methods can be used to pivotally interconnect the first and second intersecting members.

First and second intersecting members include first and second jaw portions 20 and 22, respectively, that taper toward their respective tips 24 and 26. First and second intersecting members also include first and second handle portions 28 and 30 that may be manipulated to pivotally move the jaw portions 20 and 22 between their open and closed positions. The first and second jaw portions each preferably include a generally planar gripping surface 20a and 22a.

In a preferred embodiment, the jaw portions 20 and 22 are provided with a recess. In an alternative embodiment, the jaw portions can be provided with a similar recess at one side 32 of the tool while at the other side 36 of the tool, the jaw portions 20 and 22 can be provided with a pair of sharp edges that may be used for cutting wire and the like in a well known manner.

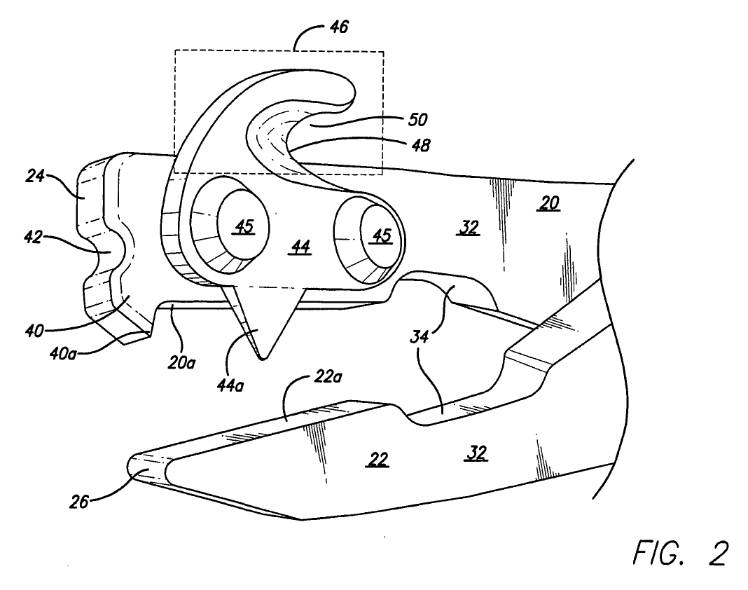

As best shown in FIG. 2, the upper jaw 20 of the tool 10 is equipped with a first split ring opener 40. Opener 40 is formed integrally with first jaw portion 20 (or second jaw portion 22, in the alternative) during the forging process. As can be seen in FIG. 2, opener 40 has a point end 40a that is adapted to pass between the convolutions of split rings. Opener 40 extends generally in a direction perpendicular to a longitudinal axis Al formed by first jaw portion 20. In a closed position, the point end 40a of opener 40 overlaps the tip 26 of second intersecting member 14.

In a preferred embodiment, the tip 24 of first intersecting member 12 includes a notch 42 defined therein for accepting one of the convolutions of a split ring. This aids in holding the split ring in place while working with the split ring as desired. It will be understood that the notch 42 is defined at a location in the tip 24 adjacent the first split ring opener 40 so that the desired result of holding a convolution of a split ring in place is reached in use. This will be readily understood by those skilled in the art.

As shown in FIG. 2, in a preferred embodiment, the upper jaw 20 of the tool 10, as seen in the drawings, is further equipped with a second split ring opener 44. The second split ring opener is attached to side 32 of first jaw portion 20 (or second jaw portion 22, in the alternative). In a preferred embodiment, the second split ring opener 44 is riveted to the side 32 of the first jaw portion 20 with at least one rivet 45 (FIG. 2 shows two rivets 45). However, it will be understood that the opener 44 can be attached to the first jaw portion 20 in any known way, such as welding, brazing, adhering or the like.

The second split ring opener 44 includes a point end 44a that serves as the probe in opening split rings, and a main body portion 44b. Preferably, the point end 44a extends generally in a direction perpendicular to longitudinal axis A1 formed by first intersecting member 12. The point end 44a overlaps side 32 of the second intersecting member 14 when the tool 10 is in the closed position.

In a preferred embodiment, the second split ring opener 44 is equipped with a cutting portion 46. Preferably, the cutting portion 46 is formed integrally with the remainder of the second split ring opener 44. However, the cutting portion 46 can also be formed integrally with one of the jaw portions. The cutting portion 46 includes a cutting edge 48 and a channel 50 defined in the opener 44 that extends away from the cutting edge 48, such that a fishing line or other object to be cut can be inserted through the channel 50 and cut on the cutting edge 48. As shown in FIG. 1, in a preferred embodiment, the point end 44a of opener 44 is located on one side of axis Al and the cutting edge 48 and insertion slot 50 are located on the other side of axis Al.

As shown in FIG. 1, in a preferred embodiment, the tool 10 includes a spring member 52 for normally biasing the first and second jaw portions 20 and 22 in the open position. The spring member 52 includes two arms 52a and 52b that are received in openings 54 in the first and second handle portions 28 and 30. The tool 10 can also be manufactured and/or used without the spring member 52.

The embodiments described above are exemplary embodiments of the present invention. Those skilled in the art may now make numerous uses of, and departures from, the above-described embodiments without departing from the inventive concepts disclosed herein. Accordingly, the present invention is to be defined solely by the scope of the following claims.

What is claimed is:

1. A tool comprising first and second intersecting members pivotable at their intersection between an open position and a closed position, the first and second intersecting members including first and second handle portions and first and second jaw portions, respectively;
a) one of the first and second jaw portions including a first split ring opener formed integrally therewith; and
b) one of the first and second jaw portions including a second split ring opener attached thereto.

2. The tool of claim 1 wherein the first split ring opener is formed integrally with the first jaw portion and the second split ring opener is attached to the first jaw portion.

3. The tool of claim 2 wherein the first split ring opener is formed on a tip of the first jaw portion and overlaps a tip of the second jaw portion when the first and second intersecting members are in the closed position.

4. The tool of claim 3 wherein the second split ring opener is attached to the first jaw portion at a location between the tip and the intersection of the first and second intersecting members, and wherein the second split ring opener overlaps a side of the second jaw portion when the first and second intersecting members are in the closed position.

5. The tool of claim 4 wherein the second split ring opener includes a cutting portion formed integrally therewith, the cutting portion including a cutting edge and defining an insertion slot extending away from the cutting edge.

6. The tool of claim 1 wherein the second split ring opener includes a cutting portion formed integrally therewith, the cutting portion including a cutting edge and defining an insertion slot extending away from the cutting edge.

7. The tool of claim 4 wherein the second split ring opener is riveted to the first jaw portion.

8. The tool of claim 4 wherein the first jaw portion defines a longitudinal axis and wherein the first split ring opener is oriented at approximately a right angle to the longitudinal axis.

9. The tool of claim 8 wherein the tip of the first intersecting member includes a notch defined therein.

10. The tool of claim 5 wherein the tip of the first intersecting member includes a notch defined therein.

11. A tool comprising first and second intersecting members pivotable at their intersection between an open position and a closed position, the first and second intersecting members including first and second handle portions and first and second jaw portions, respectively, the first intersecting member including a split ring opener attached thereto at a location between its tip and the intersection of the first and second intersecting members, wherein the split ring opener includes a cutting portion formed integrally therewith, the cutting portion including a cutting edge and defining an insertion slot extending away from the cutting edge.

12. The tool of claim 11 wherein the split ring opener overlaps the second jaw portion when the first and second intersecting members are in the closed position.

13. The tool of claim 11 wherein the first jaw portion defines a longitudinal axis and wherein the point end of the split ring opener is located on one side of the longitudinal axis and the insertion slot is located on the other side of the longitudinal axis.

14. The tool of claim 13 wherein the split ring opener is riveted to the first jaw portion.

15. A tool comprising first and second intersecting members pivotable at their intersection between an open position and a closed position, the first and second intersecting members including first and second handle portions and first and second jaw portions, respectively,
wherein the first jaw portion includes a first split ring opener formed on a tip thereof, wherein the first split ring opener overlaps a tip of the second jaw portion when the first and second intersecting members are in the closed position, and wherein the first jaw portion defines a longitudinal axis and the first split ring opener is oriented at approximately a right angle to the longitudinal axis,
wherein the first jaw portion further includes a second split ring opener attached thereto at a location between the tip and the intersection of the first and second intersecting members, wherein the second split ring opener overlaps a side of the second jaw portion when the first and second intersecting members are in the closed position, and wherein the second split ring opener includes a cutting portion formed integrally therewith, the cutting portion including a cutting edge and defining an insertion slot extending away from the cutting edge, and
wherein the tip of the first intersecting member includes a notch defined therein.

16. A method for making a split ring opening tool, the method comprising the steps of:
a) providing first and second intersecting members pivotable at their intersection between an open position and a closed position, wherein the first and second intersecting members include first and second handle portions and first and second jaw portions, respectively;
b) forming a first split ring opener on a tip of the first jaw portion;
c) attaching a second split ring opener to one of the first or second jaw portions at a location between the tip and the intersection of the first and second intersecting members, wherein the second split ring opener includes a cutting portion formed integrally therewith, the cutting portion including a cutting edge and defining an insertion slot extending away from the cutting edge; and
d) defining a notch in the tip of the first intersecting member.

17. The method of claim 16 wherein the first split ring opener overlaps a tip of the second jaw portion when the first and second intersecting members are in the closed position, and wherein the first jaw portion defines a longitudinal axis and the first split ring opener is oriented at approximately a right angle to the longitudinal axis.

18. The method of claim 17 wherein the second split ring opener is attached to the first jaw portion and overlaps a side of the second jaw portion when the first and second intersecting members are in the closed position.

19. The method of claim 17 wherein the second split ring opener is attached to the second jaw portion and overlaps a side of the first jaw portion when the first and second intersecting members are in the closed position.
